(19) United States
(12) Patent Application Publication
(10) Pub. No.: US 2023/0028775 A1
(43) Pub. Date: Jan. 26, 2023

(54) FRONT/BACK PET PACK CARRIER

(71) Applicants: Sunny K. Beermann, Littleton, CO (US); Cynthia Rae Nelson, Longmont, CO (US)

(72) Inventors: Sunny K. Beermann, Littleton, CO (US); Cynthia Rae Nelson, Longmont, CO (US)

(21) Appl. No.: 17/380,740

(22) Filed: Jul. 20, 2021

(51) Int. Cl. A01K 1/02

(52) U.S. Cl. CPC A01K 1/029

(57) ABSTRACT

The invention comprises a pet carrier that can be used on the front or back of the pet owner’s body and is designed for both durability and comfort. Clear mesh panels allow the pet to see out, and the entire padded bottom panel is expandable by unzipping the panel which then expands the height of the carrier to allow for more room. The bottom widens to 8.5 cm, which is a full 5 cm difference.

### FIELD

The invention relates to a novel pet pat carrier which may be carried on the front or back by the pet owner.

### BACKGROUND OF THE INVENTION

The invention most closely corresponds with USPTO Class 119/453 wherein Class 119 relates to animal husbandry and sub-class 453 relates to a cage includes structure which facilitates its mobility or use thereof for shipment of a confined animal.

In its simplest form, the invention comprises a novel pet carrier in a backpack form, and which may be used on the front or the back of the pet owner for transporting their pet.

Most body pet carriers are either backpacks, or “front-packs”. There are no universally front OR back carriers on the market.

### THE INVENTION

### Summary, Objects and Advantages

Of course there are many pet carriers on the market. Some need to comply with air travel regulations and some are created just for casual walks. The one issue in common, however, is the need to a fairly sophisticated pet carrier. The Applicant believes they have achieved the ideal in the market. In Hoskinson for example, the carrier can be used over the shoulder, but is open and does not fully enclose the pet (US10/932,438). In Christian the carrier is essentially a hard box with straps but cannot be used in a backpack style (US10/842,125). Lu claims a collapsible carrier with one opening for inserting and removing a pet and does have 2 straps to be carried on the back of a user only. Lu does not have capability to be carried on the front of a user nor then does it have the multiple body straps the inventive carrier does. The sides of this carrier are hard material. This carrier only comes close to the inventive carrier by having shoulder straps and at least one mesh opening (US10/743,515).

The inventive carrier has multiple features that make it ideal for a pet and its owner. Two shoulder straps are formed of layered materials with a first layer of mesh, an inner layer of foam and an outer layer of polyester twill. The layer seams are set-in binding with bartack. are two straps which can connect the carrier to either the front or the back of a pet owner. Only 2 zippers on the top of the carrier zip back to expose an entrance aperture for the pet, and wherein the doubles zippers create a single flap of material which will essentially peel back and expose the way to insert and remove the pet.

On the front of the carrier there is a single zippered pocket for inserting items whether it be car keys, leashes or treats for the pet. A single zippered pocket makes it simple for a pet owner to stow away items and eliminates multiple sized pockets which do not always offer optimum choices due to sizes of items the owner whishes to stow away.

An interior neck rest with spacer mesh is set into the interior of the carrier base and finished with binding. Center top body straps are made of 2.5 cm webbing end set into edge turned seam of exterior body panel. The edges of webbing set to exterior body panel and mesh until zipper beginning. The webbing is turned in 4.5 cm with a top snap set through webbing. A center hip a strap is attached to the carrier with DNTS set to back base and through. A plastic interior is 3 mm with piping set into mid strap seam. The seam is turned in and set to piping binding with SNTS. The end of piping set into STRAP BINDING w/ PIPING COVER; Piping allows piping slider to slide up and down piping.

### BRIEF DESCRIPTION OF THE DRAWINGS

The invention is described in further detail by reference to eight (8) drawings sufficient in detail to describe the invention in which:

FIG. 1 is a perspective of the reversible pet carrier with no pockets or apertures open;

FIG. 2 is a rear perspective of the reversible carrier;

FIG. 3 is an angled perspective to show the shoulder straps in clearer detail;

FIG. 4 is a rear perspective of the carrier with all zippers and apertures closed;

FIG. 5 is a magnified perspective of the special stitching and attachments points to the main body of the reversible carrier;

FIG. 6 is a simple bottom view of the reversible carrier;

FIG. 7 is an illustration of unzipping to expand the bottom of the reversible carrier side perspective of the ball; and

FIG. 8 is a right side perspective of the reversible carrier

### DETAILED DESCRIPTION, INCLUDING BEST MODES OF CARRYING OUT THE INVENTION

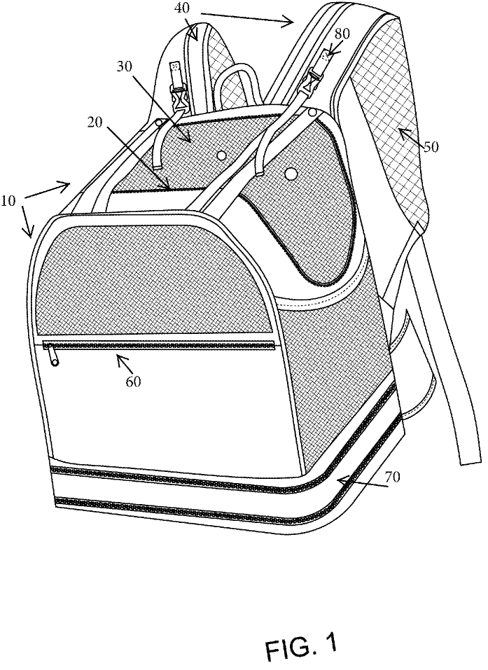

FIG. 1 shows the entire carrier 10. Zippers 20 to open the top mesh window wherein there is a zipper on either side of the center mesh panel 30. The top mesh window and door 40 is set-in sewn with zippers with double sliders set around exterior of the window/door beside front section in between set webbing. The carrier also has a front zipper pocket 60 with two layers and zipper end tabs which seal the top and sides of the carrier. The bottom layer of the carrier’s base is expandable. The base 70 has a 113 cm zipper set into the expandable bottom panel of the carrier. Shoulder straps 40 are padded and have mesh 50 on the body side of the straps for comfort and wicking of moisture. The panel set around the entire exterior of carrier uses a tuned construction and base using turned construction. When zipped, the base is 3.2 cm when unzipped, the base is 8.5 cm wide. The buckle catch end webbing 80 is single layer webbing turned through catch end of buckle and set to strap with a box stitch extending all the way through the strap.

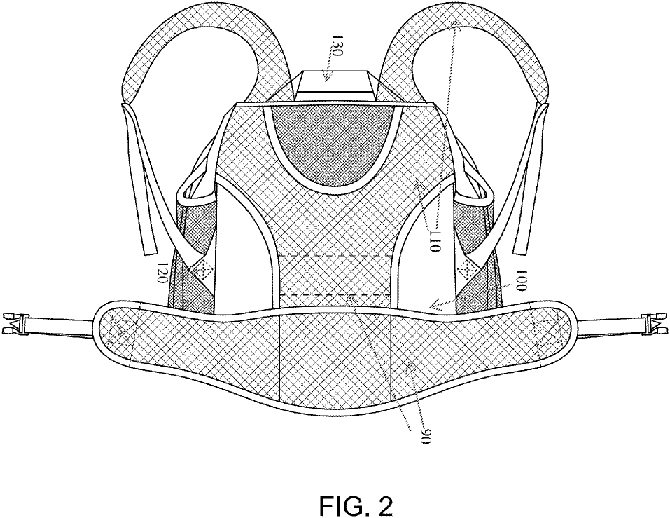

FIG. 2 is a rear perspective of the carrier showing the expanse of webbing 90 sewn onto the body side of the carrier. The webbing 90 is a 2-piece layer set into the back base seam 100. The exposed exterior edge of the webbing cover sets layers and shoulder strap cover 110. The shoulder strap webbing is set into the base back, and webbing cover furtherer set to webbing with 1 inch Box Stitch 120 with 5 SPI. A loop of fabric forms a handle 130 is 3.81 CM webbing set into top seam of carrier. Re-enforced interior by bar tack stitches on each edge. Folded and stitched at the center for handle grip for ease of lifting the carrier.

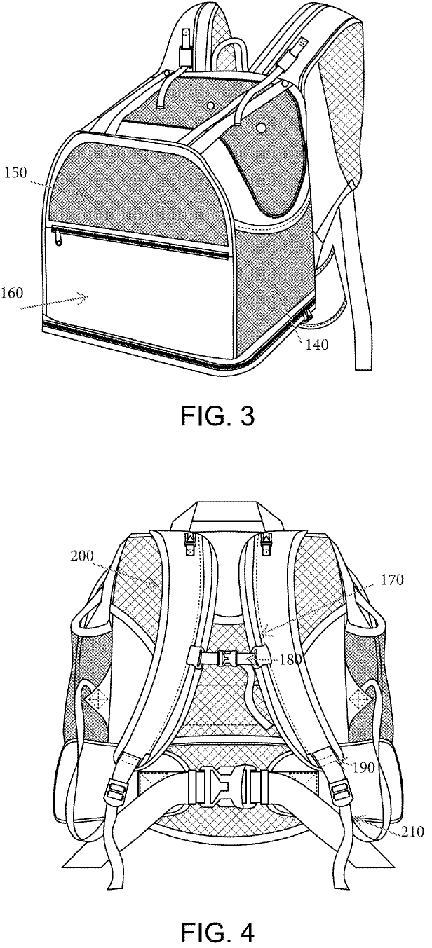

FIG. 3 shows one of two side mesh pockets 140 wherein sides and bottom are set into turned seam top set with elastic binding and left open to make 2 functional pockets. A front mesh window 150 is set in between the window edge panel and zipper. The interior edges of the front mesh window panel and window include a zipper and covered binding 160 in interior side of the carrier. An exterior body panel is set into the carrier with turned seam construction. Again, the expandable bottom is illustrated, and which has a 113 cm zipper set into the bottom panel of the carrier. The panel is set around the entire exterior of the carrier using a tuned construction. When zipped the expandable bottom is 3.2 cm wide. When unzipped fully the expansion is 8.5 cm wide. Plastic piping is set in with turned seam construction.

FIG. 4 shows the rear side of the carrier. A sternum strap 170 is 2 cm webbing and travels through catch end buckle 180 and piping slider 190. Mesh webbing is set to a shoulder strap 200 with turned seam 1.0 cm set to webbing loop with bartack. 2 cm webbing travels through hook end buckle & piping 190 slider; webbing set to piping slider w/ folded seam at 1.0 cm bartack to make a loop around slider 210 exterior end of webbing set with bartack w/ double folded end with 5.5sm loop.

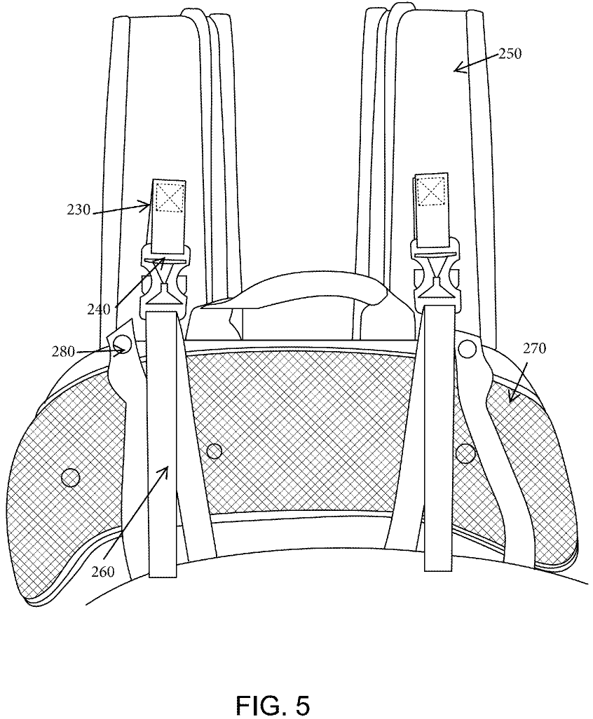

FIG. 5 illustrates the center and top of the carrier. The buckle catch end webbing 230 is single layer webbing turned through catch end of buckle 240 and set to strap with box stitch through and through. Top front support straps 250 have single layer webbing through hook end of buckle and set to seam of the exterior body panel. Center top body straps 260 are 2.5 cm webbing end set into edge turned seam of the exterior body panel 270 of webbing set to exterior body panel and mesh. The straps each have a single snap 280 as attachment support to the body panel 270.

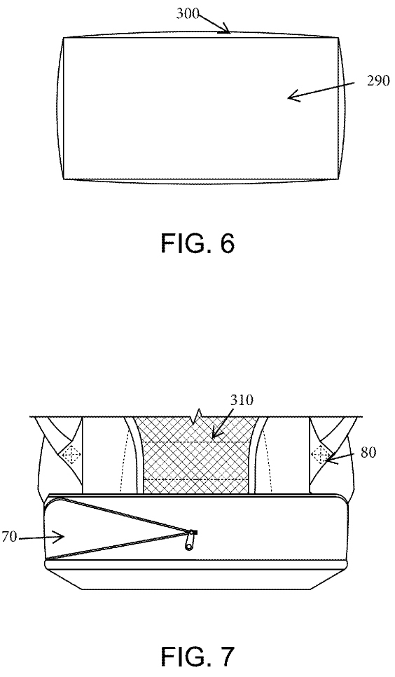

FIG. 6 is the bottom of the carrier 290 with side extrusions depicting the side pockets of the carrier 300. Inserted, but not shown in this Figis an insert base case with which is removeable and crafted from foam and plastic bond layers.

FIG. 7 is the back of the carrier showing the expandable zipper bottom 70. A section of mesh webbing is set to the body panel 310. The buckle catch end webbing 80 is single layer webbing turned through catch end of buckle and set to strap with a box stitch extending all the way through the strap.

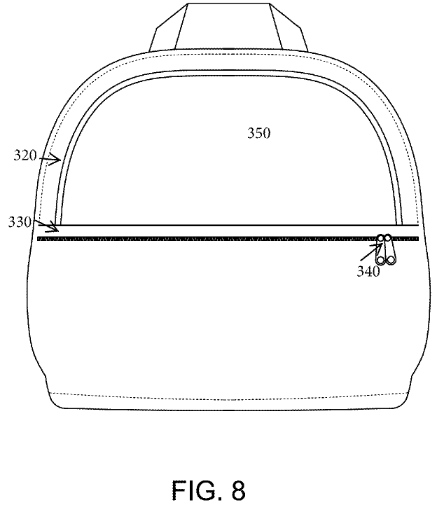

FIG. 8 shows the side of the carrier. The window edge panel 320 is a single layer set into turned seam of top panel of carrier. End seams are set into zipper gussets 330. A double zipper 340 pulls to either side to open the pocket. The side window 350 is mesh panel so the pet can see out as well as allow for airflow.

1. A front/back pet pack carrier comprising;
b) a single body handle on top of the carrier
c) a single top mesh window and door combination
d) an exterior body panel including piping
e) a single front mesh window
f) a single lined front zipper pocket
d) two side mesh pockets located on either side of the carrier
e) an expandable base panel
f) interior neck rests
g) only two center top structural straps
h) two adjustable shoulder straps with layered materials
i) a back center accent of layered materials
j) an adjustable center waist belt strap of layered materials
k) two box-stich attachment points on the base of the shoulder straps
1) a single adjustable sternum strap
m) a single plastic and foam insert for the base of the carrier
n) two points of box stitched webbing at the connection points of one waist belt.

2. A front/back pet pack carrier as in claim 1 wherein a loop of 3.81 cm webbing is set into the top seam of carrier, reinforced into the seam with bartack stitches on each edge, and is folded and stitched at the center for handle grip.

3. A front/back pet pack carrier as in claim 1 wherein the single mesh window and door combination is located at the top of the carrier and set into the exterior body panel with a zipper with double sliders set around exterior of the window/door beside front section in between set webbing so that a pet may be inserted and removed via the door and be able to see out the window portion of the combination.

4. A front/back pet pack carrier as in claim 1 wherein the exterior body panel is a rip-stop material is present throughout the carrier and in areas covered by mesh or other materials as specified through these claims.

5. A front/back pet pack carrier as in claim 1 wherein a single mesh panel forms a window on the front top of the carrier and set in between the zipper and window edge panel wherein the window is mesh and wherein the zipper and binding are covered in the interior side of the carrier.

6. A front/back pet pack carrier as in claim 1 wherein the single front zipper pocket is two-layer rip stop fabric with one zipper and end tabs sealing the zipper ends and pocket is turned into carrier sealing the sides and the bottom outer layer turned in and topset to the expandable base wherein an interior lining is set into interior binding.

7. A front/back pet pack carrier as in claim 1 wherein only two mesh pockets are located on each side of the carrier wherein the sides and bottom of the pockets are set into turned seam top set with elastic binding and left open at the top for a functional pocket without closures of any type.

8. A front/back pet pack carrier as in claim 1 wherein the base panel of the carrier is expandable from 3.2 cm when zipped and 8.5 cm when unzipped and fully expanded and wherein the panel is set around entire exterior base of the carrier using a turned seam construction and wherein the zipper is 113 cm.

9. A front/back pet pack carrier as in claim 1 wherein two interior neck rests with spacer mesh are single layer and folded in half and wherein each end is set into the interior of the carrier and having finished ends with binding and a zipper.

10. A front/back pet pack carrier as in claim 1 wherein two top structural straps are located on each side of the top of the carrier end turned seam set into edges of the exterior body panel and mesh up to the beginning of the rear panel opening zipper and wherein the strap width is 4.5 cm and contains a snap set through the webbing and attaches to the carrier body.

11. A front/back pet pack carrier as in claim 1 wherein two adjustable shoulder straps are located on one side of the carrier and are layered mesh and rip-stop materials set with binding in seam with bartack. The straps are 44 cm when extended and are anchored at the base of the carrier with a two-piece layer set into back base seam and wherein the exposed exterior edge of webbing cover sets layers and seam. Shoulder strap webbing cover is further set to webbing with 1-inch box stitch.

12. A front/back pet pack carrier as in claim 1 wherein an accent layer is set to the back center of the carrier and is comprised of layered 10 mm foam mesh and twill materials set with 3 cm binding set in seam with bartack then set onto back base layer through and through wherein the mesh partially covers the twill fabric which is then covering a plastic back board for structural support.

13. A front/back pet pack carrier as in claim 1 wherein an adjustable waist strap has a box stitched webbing on each point of connection to the carrier body, wherein the edge of the webbing is turned under and is 2.5 cm thick and wherein the box stich sets are 3.81 cm of webbing set to the waist belt. The waist belt webbing travels through the hood end of a quick release buckle, and wherein nylon material weaves through the buckle ends with excess material so as to be adjustable.

14. A front/back pet pack carrier as in claim 1 wherein a single sternum strap is 2 cm webbing and travels through catch end buckle and piping slider, webbing is set to the shoulder straps with turned seam 1.0. cm set to webbing loop with bartack, and 2 cm webbing travels through hook end buckle and piping slider wherein the webbing is set to piping slider with folded seam at 1.0 cm bartack to make a loop around slider and wherein the exterior end of webbing is set with bartack with double folded end and 5.5 cm loop.

15. A front/back pet pack carrier as in claim 1 wherein a single insert for forming and supporting the base of the carrier is turned construction with turned in edges and made of a layer of foam and a layer of plastic board and is removeable via two strips of hook and loop material affixed to the interior bottom of the carrier and the insert panel to secure the panel.
